(19) United States
(12) Patent Application Publication
(10) Pub. No.: US 2019/0063738 A1
(43) Pub. Date: Feb. 28, 2019

(54) LED BULB

(71) Applicant: Yuriy Borisovich SOKOLOV, Fryazino (RU)

(72) Inventor: Yuriy Borisovich SOKOLOV, Fryazino (RU)

(21) Appl. No.: 15/748,609

(22) PCT Filed: Jul. 28, 2015
(86) PCT No.: PCT/RU2015/000471

§ 371 Date: Jan. 29, 2018

(51) Int. Cl. F21V 29/71; F21K 9/237; F21K 9/238; F21V 29/74; F21V 29/83; F21V 29/85; F21V 29/89

(52) U.S. Cl. CPC F21V 29/713; F21K 9/237; F21K 9/238; F21Y 2115/10; F21V 29/83; F21V 29/85; F21V 29/89; F21V 29/74

(57) ABSTRACT

The invention relates to lighting technology, and specifically, to designs of general-purpose LED bulbs. The technical result of the claimed solution is an improvement in the removal of heat from light-emitting diodes and from a power source, and an increase in the manufacturability and lighting efficiency of a bulb. The LED bulb comprises a body-cum-radiator covered with a dielectric heat-conductive plastic; a base plate with light-emitting diodes; a diffuser covering the light-emitting diodes; a power source; and a cap. The body-cum-radiator comprises two combined aluminum profiles, the inner and outer surfaces of which are covered with a dielectric heat-conductive plastic, the outer wall has extended ends and a flat surface section which is equipped with heat-removing cooling fins, wherein the heat-removing fins of a first part of the body-cum-radiator are oriented towards the heat-removing fins of a second part of the body-cum-radiator and mounted with a gap; the base plate of the light-emitting diodes is mounted on flat sections of the surface of each aluminum profile; and the extended ends of the outer wall of each aluminum profile are connected to the cap with the aid of the dielectric heat-conductive plastic, from the material of which an enclosure is formed for accommodating the power source, the enclosure being separated from the aluminum profile by an air gap.

### PERTINENT ART

The invention belongs to lighting engineering, specifically to the design of general purpose LED-based lamps.

### STATE OF THE ART

General purpose LED-based lamps possess, as a rule, the following basic units and elements: axisymmetric convex light-diffusing envelope, board with light-emitting diodes (LEDs), convective heat exchange radiator, built-in power supply source and adapter plug for connecting to power line, various additional units and elements which can rise efficiency of operation of the lamp.

Maintaining of the operating temperature regime of LEDs and power supply source is one of the most essential issues, whereas their reciprocal thermal influence is one independent problem. In any case, the problem of excessive heat withdrawal is solved by means of convection heat flow and heat radiation from the radiator surface into ambient air. The more powerful is the lamp, the more actual is the problem of quick withdrawal of heat to the heat flow surface into ambient air.

Known is light-emitting diode (LED) containing box-radiator made of dielectric insulating material and possessing surface of convection heat exchange with ambient air; diffuser of LEDs radiation fixed on the box-radiator; board-mounted LEDS; heat conducting element mounted with possibility of heat exchange with LEDs board and with box-radiator; power source of LEDs; and adapter plug (TW 201405067; IPC F21V3/04, published on 1 Feb. 2014).

Defective features of the known solution are that this design makes it difficult to create a high power LED lamp at acceptable dimensions thereof due to insufficient heat withdrawal from LEDs, heat radiation whereof is restricted, on one side, by the air pad under diffuser, and on the other side, by the closed cavity inside the radiator wherein the power supply source is placed which, in turn, is also a heat source. LEDs and power supply source negatively influence each other, whereas the power supply source occurs to be a weak link the operating temperature whereof should be considerable lower than it can be for LEDs.

Other solutions are known, e.g. CN203477931 U, JP539258782 B2, CN 203500894 U, CN203731137 U, whose common feature is presence of LED light radiation diffuser and location of the power supply source within the closed volume of the lamp body, whereas the power supply source is subject to thermal influence from LEDs.

One has to mention availability of an international application PCT/RU 2014/000997 by the author with priority of 26 Dec. 2014 wherein the design of LED is described which contains board of LEDs equipped with heat dissipater the whole surface whereof is a surface of heat flow and thermal radiation.

The solution described in TW 201405067 is chosen as a prototype, as it is the most approximate to the claimed solution in terms of coinciding features.

The technical result of the claimed solution is improving of heat withdrawal from LEDs and power supply source, enhanced produceability and light efficiency of the lamp.

### DISCLOSURE OF THE INVENTION

The claimed invention is characterized with the following cumulative features: LED-based lamp having box-radiator coated with dielectric heat-conducting plastic; printed-circuit board with light-emitting diodes; diffuser covering light-emitting diodes; power supply source; and adapter plug characterized in that the box-radiator consists of the first and second part each of them includes combined aluminum section the internal and external surface whereof is coated with dielectric heat-conducting plastic, external walls possesses elongated ends and a flat area of the surface equipped with heat removing cooling fins, whereas these heat removing fins of the first part of box-radiator are oriented towards heat removing fins of the second part of box-radiator and mounted with a gap; LEDs board is mounted on the flat areas of surface of each aluminum section; while elongated ends of the external wall of each aluminum section are connected with adapter plug by means of dielectric heat-conducting plastic, in the material whereof between elongated ends of the external wall a niche is made for placing of the power supply source, the mentioned niche separated from the aluminum section with an air gap.

In one variant, the combined aluminum section contain hollow spaces of elongated shape, while heat removing fins which restrict these spaces will connect the flat area and elongated ends of the aluminum section.

In another variant, the combined aluminum section has one or multiple closed cavities adjacent to the flat area of the section whose walls are heat removing fins.

An important advantage of this claimed LED-based lamp is minimization of dependence of the temperature regime of the power supply source on LEDs temperature, which allows to drastically increase service life of the lamp. This advantage is achieved due to allocation of the power supply source in a niche made of dielectric heat-conducting plastic and separated from the aluminum section by an air gap, and due to significant increase of the area of heat dissipation from the niche surface into the ambient air, in addition to the high heat dissipation from the entire surface of heat removing fins.

### BRIEF DESCRIPTION OF DRAWINGS

The claimed solution is illustrated with the following graphics:

FIG. 1: 3D image of the variant of LED-based lamp in assembly,

FIG. 2: 3D image of the variant of LED-based lamp from FIG. 1 disassembled,

FIG. 3: Top view of the variant of LED-based lamp,

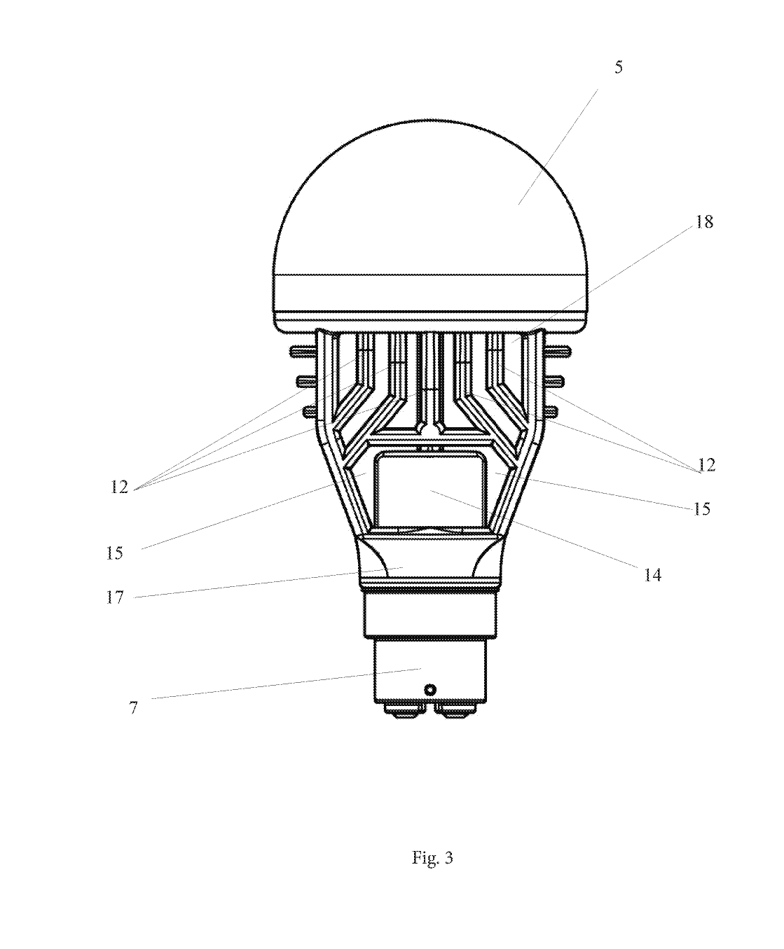

FIG. 4: Cross-section of the LED-based lamp shown in FIG. 3,

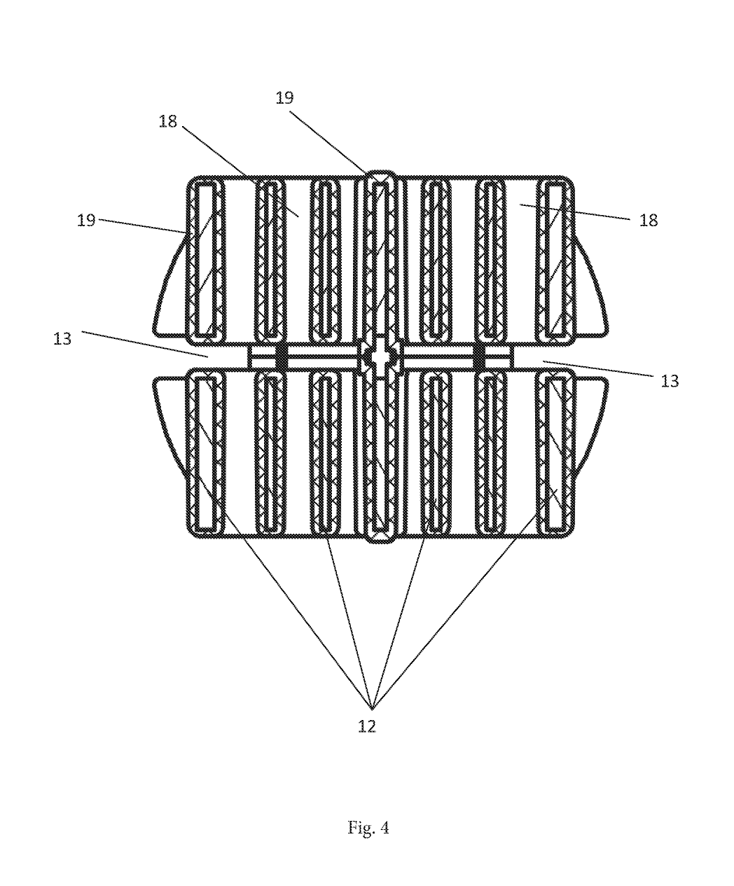

FIG. 5: Drawing of aluminum section of the variant LED-based lamp shown in FIG. 2,

FIG. 6: First axial section of LED-based lamp shown in FIG. 1,

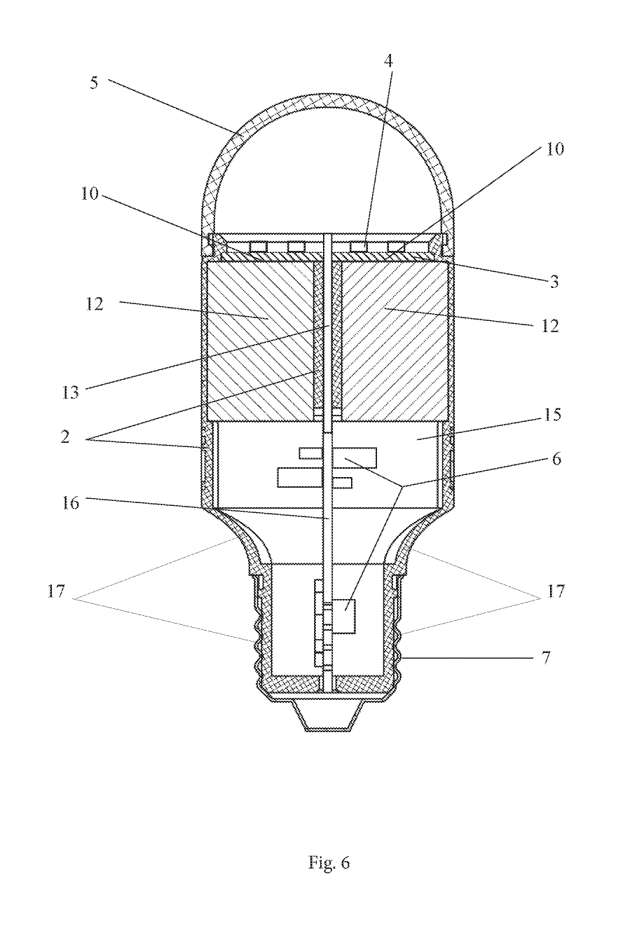

FIG. 7: Second axial section with the plane passing in the gap between parts of the box of LED-based lamp shown in FIG. 1.

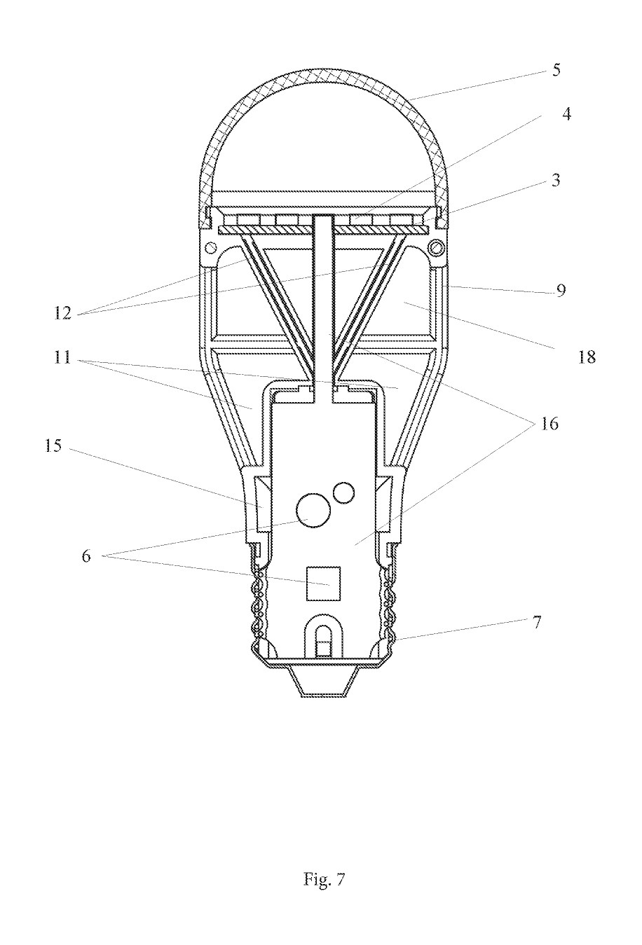

### LIST OF ITEMS IN THE DRAWING

1. Box-radiator of LED-based lamp,
2. Layer of dielectric heat-conducting material,
3. LEDs board,
4. LEDs,
5. Diffuser,
6. Power supply source,
7. Adapter plug,
8. Combined aluminum section,
9. External wall of combined aluminum section,
10. Flat area of combined aluminum section,
11. Elongated ends of external wall of combined aluminum section,
12. Walls of aluminum section functioning as heat removing fins,
13. Gap between heat removing fins of the first and second part of box-radiator,
14. Niche for allocation of power supply source elements,
15. Air gap between the niche of power supply source and the aluminum section,
16. Power supply source board,
17. Transition elements of the box moulded of heat-conducting plastic,
18. Ventilation cavities,
19. Fastening elements of diffuser.

LED-based lamp contains box-radiator 1 coated with dielectric heat-conducting plastic 2; board 3 with light-emitting diodes (LEDs) 4; diffuser 5 covering LEDs 4; power supply source 6; and adapter plug 7. Box-radiator 1 includes the first and second removable parts, each of them containing combined aluminum section 8, external wall 9 whereof has a flat area 10 and elongated ends 11, whereas internal surface of this flat area 10 is equipped with heat removing fins 12. Heat removing fins 12 of the first part of box-radiator 1 are oriented towards heat removing fins of the second part of box-radiator 1. This reciprocal allocation of heat removing fins 12 creates ventilation cavities 18 which ensure through-flow ventilation of box-radiator 1 in one direction. To ensure efficiency of convection heat withdrawal at any position of the lamp between heat removing fins 12 of the first and second parts of box-radiator 1, gap 13 is created which ensures ventilation of box-radiator 1 in the opposite direction, whereas magnitude of gap 13 is chosen depending on the amount of heat emitted by the lamp.

Board 3 of LEDs 4 is mounted on flat areas 10 of external walls 9 of aluminum section 8 of the first and second parts of box-radiator 1. Whereas, elongated ends 11 of external wall 9 of each aluminum section 8 are connected with adapter plug 7 by means of transition elements 17 which are formed from dielectric heat-conducting plastic 2 simultaneously with filling of each of parts of box-radiator 1. Niche 14 for power supply source 6 is created by filling of dielectric heat-conducting plastic 2 and separated from aluminum section 8 by means of air gap 15, thus ensuring independence of the temperature regime of power supply source 6 and drastic increase service life of the lamp. Power supply source 6 is mounted on board 16 which is installed along the axis of box-radiator 1 and provides eclectic connection of adapter plug 7 with board 3 of LEDs 4.

### EMBODIMENT EXAMPLES

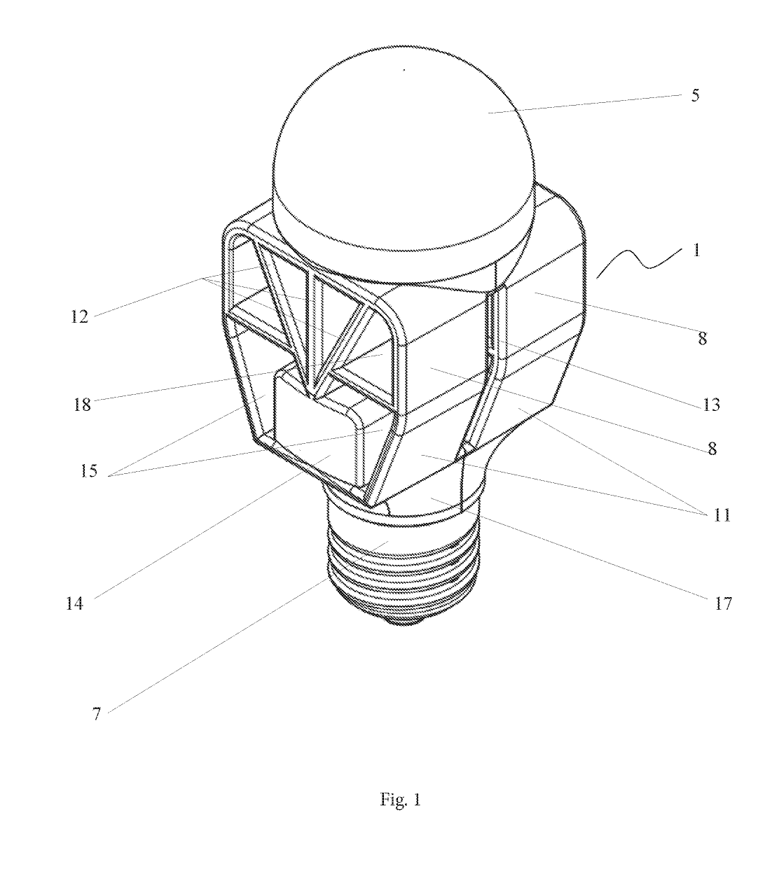

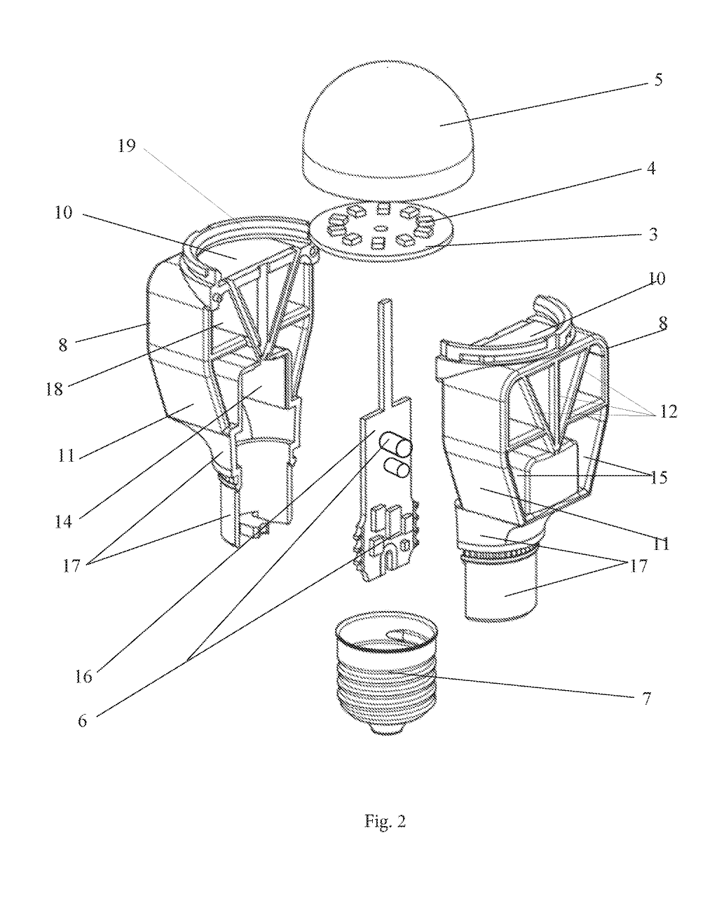

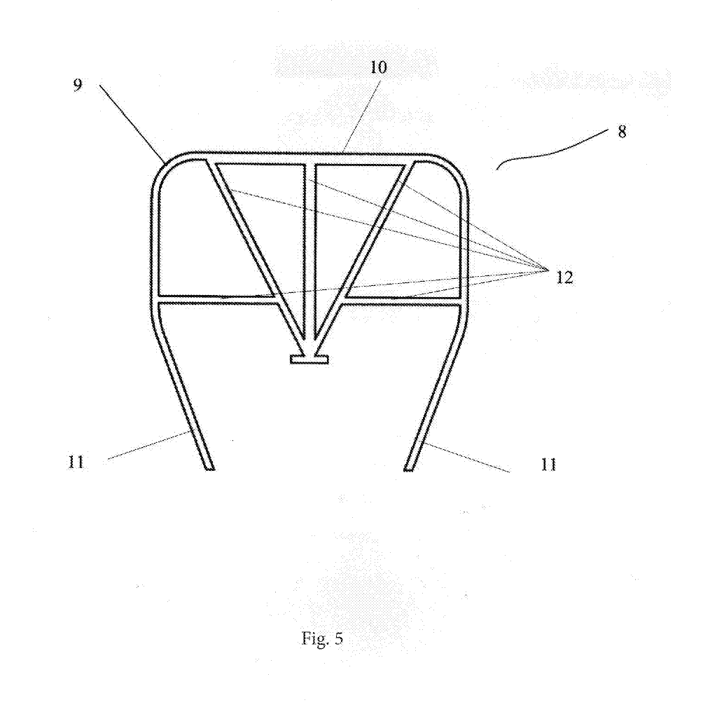

Shown in drawings FIG. 1 and FIG. 2 is the preferred embodiment containing the assembled box-radiator 1 made of two, essentially symmetric parts, each of them includes identical aluminum sections, for example, like shown in FIG. 5 coated with dielectric heat-conducting material 2 all round. Heat removing fins 12 connect flat area 10 with elongated ends 11 of external wall 9 of aluminum section 8. Heat is removed partially also via external wall 9 of aluminum section 8. Created between heat removing fins 12 are ventilation cavities 18 which are able to ensure free air convection.

Surface of niche 14 with power supply source 6 is surrounded with air gap 15 in such a way that the heat emitted by LEDs 4 practically does not affect operation of power supply source 6 which is mounted on vertically installed board 16 electrically connected with board 3 of LEDs 4 which is installed on the surface of flat area 10 of aluminum sections 8. Electronic components of power supply source 6 are mounted on vertical board 16, whereas a certain part of these components is located in the part of board 16 which is located in adapter plug 7, while suspended large-format components of power supply source 6 are mounted in such a way that they are located in niche 14.

Elongated walls 11 are connected with adapter plug 7 by means of heat-conducting plastic 2, from the material whereof transition elements 17 are formed.

Assembling of this variant of LED-based lamp is performed as follows. On the prepared first half of box-radiator 1 which includes extruded aluminum section 8 coated all round with dielectric heat-conducting plastic 2 and formed from this plastic transition elements 17, half of niche 14, half of fastening element 19 for diffuser 5—board 16 of LEDs 4 is located on flat area 10 of aluminum section 8. Board 16 of power supply source 6 is mounted along the lamp axis in such a way that to ensure its electric connection with board 3 of LEDs and with adapter plug 7. The second half of box-radiator 1 prepared by the above described method is mated with the first half of box-radiator 1. Mating of the described halves of box-radiator 1 is performed by means of adapter plug 7 on cylindrical surface of transition elements 17. Mating of the parts of the box-radiator and LED-based lamp shall be finished by fastening of diffuser 5 on fastening elements 19.

Commercial Availability

The techniques of manufacturing of LED-based lamp elements are broadly known, well assimilated and provided with highly efficient process equipment with various degrees of automation.

What is claimed is:

1. An LED-based lamp comprising:
a radiator housing coated with a dielectric heat-conducting plastic;
a board with a light-emitting diode;
a diffuser, covering the light-emitting diode;
a power supply; and
an adapter plug,
wherein the radiator housing comprises a first part and a second part that are connected to each other,
wherein the first part and the second part of the radiator housing each comprise an aluminum profile having an outer wall that has elongated ends, and a flat portion on which the board with the light-emitting diode is installed,
wherein an inner side of the flat portion of the first part and the second part of the radiator housing each comprise a heat removing fin, the heat-removing fin of the first part of the radiator housing being substantially oriented like the heat-removing fin of the second part of the radiator housing,
wherein the first part and the second part are coupled together to form a first air gap,
wherein an inner and outer surface of each of the first part and the second part of the radiator housing are covered with the dielectric heat-conducting plastic, and
wherein the elongated ends of the outer wall of first part and the second part of the radiator housing are connected to the adapter plug by the dielectric heat-conducting plastic.

2. The LED-based lamp according to claim 1, wherein the power supply is located in a niche that comprises the dielectric heat-conducting plastic and which is located between the elongated ends of the outer wall of the first part and the second part of the radiator housing and wherein the niche is separated from a portion of the first part and a portion of the second part of the radiator housing by a second air gap.

3. An LED-based lamp comprising:
a radiator housing comprising a first half and a second half that each comprise aluminum coated with a first dielectric heat-conducting material, and that are coupled together,
a board with an LED;
a diffuser that is coupled to the radiator housing and that covers the LED;
a power supply that is electrically connected with the board and the LED; and
an adapter plug that is electrically connected with the power supply,
wherein the first part and the second part of the radiator housing each:
comprise aluminum;
comprise a flat portion on which the board with the LED is disposed; and
an outer wall with a heat-removing fin being disposed within the outer wall to form a first ventilation cavity that allows air to flow through the first part and the second part of the radiator housing in a first direction,
wherein the first part and the second part of the radiator housing are coupled together to form an air gap that is disposed between a portion of the first part and a portion of the second part of the radiator housing such that the air gap is configured to allow air to flow through the radiator housing in a second direction.

4. The LED-based lamp of claim 3, wherein the first direction is substantially perpendicular to the second direction.

5. The LED-based lamp of claim 3, wherein the radiator housing defines multiple additional ventilation cavities that extend through the first part and the second part of the radiator housing to allow air to flow through the radiator housing through the first ventilation cavity and the additional ventilation cavities in the first direction.

6. The LED-based lamp of claim 3, wherein the power source is disposed in a compartment that comprises a second dielectric heat-conducting material.

7. The LED-based lamp of claim 3, wherein the compartment is disposed between a first and second extended end of an outer wall of the radiator housing, and wherein the radiator housing defines a space between the compartment and the first and second extended ends of the outer wall to allow air to flow between the compartment and the first and second extended ends of the outer wall of the radiator housing.

8. The LED-based lamp of claim 3, wherein the radiator housing couples to a transition element comprising a second heat-conducting material, and wherein the transition element, in turn, is coupled to the adapter plug.

9. The LED-based lamp of claim 4, wherein:
the radiator housing defines multiple additional ventilation cavities that extend through the first part and the second part of the radiator housing to allow air to flow through the radiator housing through the first ventilation cavity and the additional ventilation cavities in the first direction,
the power source is disposed in a compartment that comprises a second dielectric heat-conducting material,
the compartment is disposed between a first and second extended end of an outer wall of the radiator housing,
the radiator housing defines a space between the compartment and the first and second extended ends of the outer wall to allow air to flow between the compartment and the first and second extended ends of the outer wall of the radiator housing, and
the radiator housing couples to a transition element comprising a third heat-conducting material, and wherein the transition element, in turn, is coupled to the adapter plug.

10. The LED-based lamp of claim 6, wherein the first dielectric heat-conducting material and the second dielectric heat-conducting material each comprise a matching material.

11. The LED-based lamp of claim 8, wherein the first dielectric heat-conducting material and the second heat-conducting material are each comprise a matching material.

12. The LED-based lamp of claim 9, wherein the first dielectric heat-conducting material, the second heat-conducting material, and the third heat-conducting material are formed from a first mixture of a dielectric material.
